(19) United States
(12) Patent Application Publication
(10) Pub. No.: US 2010/0281186 A1
(43) Pub. Date: Nov. 4, 2010

(54) Electric protective relay provided with a USB type connector

(76) Inventors: Itamar F. Soares, Joinville (BR); Sandro Y. G. Bastos, Jaguara do Sul (BR); Alexandre J. da Silva, Jaragua do Sul (BR)

Correspondence Address: KILE PARK REED & MCMANUS, 1200 NEW HAMPSHIRE AVE, NW, SUITE 570, WASHINGTON, DC, 20036, US

(21) Appl. No.: 12/772,579

(22) Filed: May 3, 2010

(30) Foreign Application Priority Data
May 4, 2009 (BR) PI 0901449-7

(51) Int. Cl. G06F 3/00; G06F 13/12

(52) U.S. Cl. 710/15; 710/63

(57) ABSTRACT

An electric protective relay provided with a USB type connector that is provided with at least a “USB” type or miniUSB interface connector (2) in at least one of its end that makes it possible to easily and rapidly couple computers provided with USB interfaces.

This application claims the benefit of Brazilian Patent Application No. PI 0901449-7 of May 4, 2009.

The present invention is directed to a relay provided with a “USB” type interface connector and, more specifically, to a electric protective relay that is used for setting and/or monitoring parameters by a computer, that is, for monitoring and displaying parameters in the computer, sending commands through the computer, receiving data through the computer, and interacting with a software for setting and monitoring in a simpler and easier way through the computer. As is known by all those skilled in the related art, a relay may or not be an electromechanical device, with a number of possible applications in the commutation (connection/disconnection) of electric contacts, being able to connect or disconnect electric and electronic devices. The relay is usually connected to two circuits. In the example of the electromechanical relay, the commutation is carried out by feeding the coil thereof. When a current from the first circuit passes through the device, an electromagnetic field is generated, thus activating the relay and making it possible to operate the second circuit. Thus, one of the advantages of the relay is that low currents can be used for the command in the first circuit, protecting the operator against possible high currents that will circulate in the second circuit. The types of existing relays and the applications thereof have a great diversity in several areas such as in the energy sector, for example, one of the main niches of the relay marketplace. Contrary to what most people think, the use of relays is not limited to vehicles. Rather, they are widely used in the industry, from the automation process to the products manufactured to be used in homes and marketplace.

The protective relays, on their turn, have been conceived initially for the protection of input and output feeders on MV systems. Conventionally, the communication thereof with other devices is carried out through Modbus RTU via RS-485, D-SUB/terminals and RS-232. The electronic protective relays of electric engines use a microcontroller for processing the signals that are read by sensors in order to sound alarms and/or open the feeding circuit of the engine, through the implementation of software. Another functionality attained with the use of the microcontroller is the possibility of monitoring the parameters, since they are generated by the manipulation of the signals converted by an analog-digital converter.

The fact is that, despite the fact that protective relays are widely and satisfactorily used, nowadays the visualization and monitoring of the parameters are carried out through a connection with a computer by a supervisory software, wherein the data are transmitted through a fieldbus type communication network, or even through a man-machine interface. It was thinking about this and other disadvantages that the inventor of the present application has developed a relay provided with a “USB” type connector. “USB” stands for “Universal Serial Bus” (or universal serial bus-bar) and is a technology that has made it possible to connect several types of devices (digital cameras, external drives, modems, mouses, keyboards, etc.) to the computer in a simpler and easier way, avoiding the use of a specific type of connector for each device. Thus, every computer presently acquired is provided with one or more USB gates (connectors). The operational system also supports the USB interface, thus making the installation of driver of the device fast and easy. When compared to other forms of connection of devices (including parallel gates, serial gates and special boards installed inside the housing of the machine), USB devices are incredibly simple.

Until a certain time in the past, the installation of a peripheral in the computer was an action seen as a scaring task that could be carried out only by experts or more experienced people. Among the several types of cables and connectors, first of all it was necessary to find out the computer gate to connect the peripheral in question almost through a guessing procedure. When the installation was internal, the user needed to open the computer and had to configure jumpers and/or IRQs most of the time.

The (Plug and Play) PnP standard, that means “connect and use”, was created for the purpose of providing the computer with the ability to automatically recognize and configure any device to be installed, thus making it easy to safely expand the computers and eliminating the manual configuration. This task has become easier and diminished all the existing complicated tasks required in the configuration of devices. The object of the PnP standard was to provide the inexperienced user with the ability to install a new peripheral and use same immediately, without the need to carry out complicated tasks. But this standard is still complicated for a number of people, mainly when a failure occurs for some reason.

In view of the above, in 1995 a consortium of companies was created for the purpose of developing a technology that would allow the use of a common plug and play connection between the computer and peripherals, and with all these advantages the USB interface has become the easiest way to connect peripherals to the computer. The idea of being able to connect several types of devices in a single inlet also was a factor that helped the USB to become popular. In a short time the use of USB type interfaces for the connection of peripherals of a digital computer has become a standard. With all these advantages, the USB interface has become the easiest way to connect peripherals to the computer. The manufacturers soon realized the advantages in using same and started to adopt same in their products. Because of this, the USB started to become popular and conquer its territory. The idea of being able to connect several types of devices in a single inlet also was a factor that helped the USB to conquer its territory.

Also, the USB offers another advantage: any user can install USB devices into the computer. The USB is like a “plug and play” feature, since it allows the operational system to recognize the device installed and make same available immediately. For that purpose, the motherboard of the computer and the operational system should be compatible with the USB. Besides having a “plug and play” feature, the USB interface has brought about another innovation: it is possible to connect and disconnect any USB device with the computer on, without the possibility of any damage thereto. Moreover, it is not necessary to restart the computer so that the installed device can be used. It is enough to connect same correctly and then it will be ready to be used. In the past, there was even the risk of short-circuits, if an installation with the equipment on needed to be carried out.

An interesting fact is the possibility to connect some peripherals USB to others (for example, a printer to a scanner). But this is only attained if both devices are provided with integrated USB connectors. Also, it is possible to use “USB hubs”, that is, devices that use a USB gate of the computer and also have 4 or 8 other gates. Theoretically, up to 127 USB devices can be connected to a single gate, but this is not viable, since the speed of the data transmission of all the equipment involved would be compromised. Due to restriction of physical space, several sizes of interface derived from the standard have been developed. One of such sizes is the one known as miniUSB, which is a significant reduction of the standard size and can be used in several power-consuming devices.

Therefore, the object of the present invention is to provide a protective relay provided with a “USB” type connector that makes it possible to set and/or monitor parameters through a computer with a “USE” type interface.

Another object of the present invention is to provide a protective relay provided with a “USB” type connector that makes it possible to monitor parameters for visualization in a computer with a “USB” type interface.

Another object of the present invention is to provide a protective relay provided with a “USB” type connector that makes it possible to receive data, send commands and interact with the software for setting and monitoring parameters through a computer with a “USB” type interface. Another object of the present invention is to provide a relay with a “USE” type connector that makes it possible to receive data through a computer with a “USB” type interface. Another object of the present invention is to provide a relay with a “USB” type connector that makes it possible to interact with a software for setting and monitoring parameters through a computer with a “USB” type interface. These and other objects and advantages of the present invention are attained with a relay that comprises at least one “USE” or miniUSB type interface connector (2), in at least one of its ends and allows for an easy and fast coupling to a computer provided with a USB interface.

### DRAWINGS

In order to have a clear visualization of the present invention and supplement this specification, the example of a relay with a “USB” interface connector is given below, wherein:

FIG. 1 illustrates a front view of an electric protective relay (1) provided with a “USB” type interface connector (2).

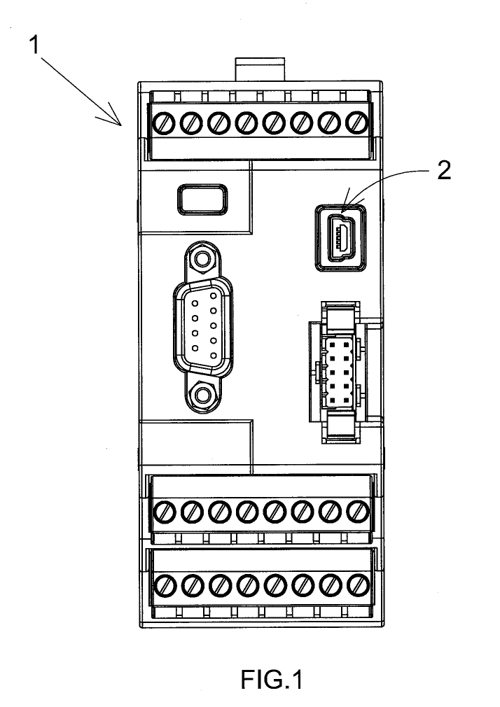

Although the preferred embodiments have been described, it should be pointed out that changes are possible and attainable without departing from the scope of the present invention.

1. An electric protective relay provided with a USB type connector, characterized by being comprised of at least one “USB” or miniUSB type interface connector (2), in at least one of its ends, that makes it possible to couple to computers provided with a USB interface.

2. The electric protective relay provided with a USB type connector according to claim 1, characterized in that it can set and/or monitor parameters with or without visualization through a computer with a “USB” type interface.

3. The electric protective relay provided with a USB type connector, according to claim 1, characterized in that it can send commands through a computer provided with a “USB” type interface.

4. The electric protective relay provided with a USB type connector, according to claim 1, characterized in that it can receive data through a computer provided with a “USB” type interface.

5. The electric protective relay provided with a USB type connector, according to claim 1, characterized in that it can interact with the software for setting and monitoring parameters through a computer provided with a “USB” type interface.
